(19) United States
(12) Patent Application Publication
(10) Pub. No.: US 2010/0068594 A1
(43) Pub. Date: Mar. 18, 2010

(54) POLYMER ELECTROLYTE MEMBRANE, METHOD OF PREPARING THE SAME, AND FUEL CELL INCLUDING THE POLYMER ELECTROLYTE MEMBRANE

(75) Inventors: Yuichi AIHARA, Yokohama (JP); Satoshi Yanase, Yokohama (JP); Manabu Takezawa, Yokohama (JP); Hiroyuki Watanabe, Yokohama (JP)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/560,909

(22) Filed: Sep. 16, 2009

(30) Foreign Application Priority Data
Sep. 17, 2008 (JP) 2008-237860
Dec. 31, 2008 (KR) 10-2008-0138716

(51) Int. Cl. H01M 8/10

(52) U.S. Cl. 429/33

(57) ABSTRACT

Provided are a polymer electrolyte membrane that is stable even at high temperatures in non-humidified conditions, thereby having high proton conductivity, a method of preparing the polymer electrolyte membrane described above, by which high productivity can be obtained, and a fuel cell with high power generation characteristics by using the polymer electrolyte membrane. In particular, there is provided a method of preparing a polymer electrolyte membrane in which a mixed solution prepared by dissolving a (hydrocarbon-based) polymer electrolyte having an acidic functional group and any one free acid source selected from the free acid, mixtures of a free acid and Lewis acid, and mixtures of a free acid and an organic salt in a polar organic solvent is subjected to wet membrane formation to prepare a polymer electrolyte membrane in which the polymer electrolyte is doped with the free acid.

### CROSS-REFERENCE TO RELATED APPLICATIONS

This application claims the benefit of Japanese Patent Application No. 2008-0237860, filed Sep. 17, 2008 in the Japanese Patent Office and Korean Patent Application No. 10-2008-0138716, filed Dec. 31, 2008 in the Korean Intellectual Property Office, the disclosures of which are incorporated herein by reference.

### BACKGROUND OF THE INVENTION

1. Field

One or more embodiments relate to a polymer electrolyte membrane, a method of preparing the same, and a fuel cell including the polymer electrolyte membrane.

2. Description of the Related Art

Fuel cells can be used in electrochemical devices, and in particular, have drawn much attention as a next generation clean energy source. Recently, research has been actively conducted on the operation of proton conductive electrolyte membranes of fuel cells at high temperatures of 100° C. or more in a non-humidified or low humidified environment. When a proton conductive electrolyte membrane operated at high temperatures in the absence of water is used, fuel cell systems can be simply manufactured to include the proton conductive electrolyte membrane and used for home cogeneration or vehicles.

A polymer electrolyte fuel cell (PEFC) is a type of fuel cell system which may be suitable for home cogeneration or vehicles. PEFCs include a membrane electrode assembly (MEA) which includes a fuel electrode, an oxygen electrode, and a proton conductive polymer electrolyte membrane interposed between the fuel electrode and the oxygen electrode. The electrolyte membrane has a catalyst and a gas diffusion layer. A hydrogen gas is supplied to the fuel electrode and air or oxygen is supplied to the oxygen electrode. An electrochemical reaction represented by the following reaction scheme is thus generated, resulting in the PEFCs obtaining an electromotive force.

(Fuel electrode)H₂→2H⁺+2e⁻

(Oxygen electrode) 2H⁺+1/2O₂+2e⁻→H₂O

An example of the proton conductive polymer electrolyte membrane described above is an electrolyte membrane having NAFION (registered trade mark), a product manufactured by DuPont, USA, or a sulfonated polyetheretherketone electrolyte membrane. In such polymer electrolytes, water molecules around sulfonic acid intervene in the proton conduction. Thus, the polymer electrolyte is generally used in a fuel cell in a constantly humidified state by humidification. Therefore, an operating temperature of such electrolyte membranes is generally 80° C. or less, and such limitation causes problems, such as CO poisoning of a catalyst, and the like. Accordingly, selective removal of CO is required, and as a result, fuel cell systems become more complicated and the manufacturing costs may increase.

To address these problems, several theories on PEFCs which operate at 100° C. or more have been proposed. In general, in power generation at 100° C. or more, the activity of catalysts is improved, CO poisoning may be decreased, and the lifespan of fuel cells increases. However, in fuel cell operation in a mid-temperature range (i.e., about 150° C.), water molecules cannot exist stably. Thus, a fuel cell including a polymer electrolyte membrane comprising polybenzimidazole which is doped with phosphoric acid, and which does not depend on a water medium has been proposed (for example, in U.S. Pat. No. 5,525,436). In such fuel cell, it is possible to generate power even in a mid-temperature range (i.e., about 150° C.).

In addition, besides the fuel cell disclosed in U.S. Pat. No. 5,525,436, a fuel cell has been proposed using a room-temperature molten salt as a medium for transferring protons. An example of a fuel cell using a general room-temperature molten salt as a medium for transferring protons is disclosed in International Patent Publication No. WO 03/083981. Examples of a method of immobilizing a room-temperature molten salt, which is liquid, include combination with polyarylene (for example, Japanese Patent Laid-Open Publication No. 2006-32213), combination with polybenzimidazoles (for example, Japanese Patent Laid-Open Publication No. 2005-166598), and combination of Zwitter ion-type molten salts and acids (for example, Japanese Patent Laid-Open Publication Nos. 2005-228588 and 2004-38683). However, polarization characteristics are very poor in such fuel cells including the room-temperature molten salts described above. For example, in International Patent Publication No. WO 03/083981, polarization curves are shown, but data on continuous power generation is not disclosed. Japanese Patent Laid-Open Publication No. 2006-32213 does not disclose data on which basis for power generation is provided. In addition, Japanese Patent Laid-Open Publication Nos. 2005-228588 and 2004-38683 disclose continuous conducting test results as a result of electrochemical measurement, but the characteristics thereof are very poor.

In addition, a method of doping a conventional NAFION (registered trade mark) perfluorosulfonic acid polymer electrolyte with phosphoric acid is disclosed in R. Savinell et al., J. Electrochem. Soc. 141, (1994) L46. An electrolyte doped with a general room-temperature molten salt is disclosed in J. Sun et al., Electrochemica Acta, 46, (2001) 1703-1708. In addition, combination of a strong acid in which sulfonated polysulfone is doped with triazole and a weak base is disclosed in Japanese Patent Laid-Open Publication No. 2006-32213. From these documents, the presence of proton transfer can be confirmed, but the documents do not fully disclose power generation characteristics. Moreover, the application of such technologies described above to fuel cells has not been fully verified.

However, as described in R. Savinell et al., J. Electrochem. Soc. 141, (1994) L46, when an acidic proton medium, such as phosphoric acid is used, proton transfer needed for power generation, as generated in the polybenzimidazole doped with phosphoric acid described above, can be relatively easily achieved. Thus, power generation is also considered to be possible.

As described in R. Savinell et al., J. Electrochem. Soc. 141, (1994) L46, in general, a polymer electrolyte membrane is formed using a wet process in a solution in which a polymer electrolyte is dissolved, and then the polymer electrolyte membrane is doped with phosphoric acid. However, physical properties of the polymer electrolyte membrane before and after the doping process are significantly different. Further, a long period of time is required in order to dope the electrolyte membrane with a sufficient amount of phosphoric acid in order to reach a state of equilibrium. In addition, when a consecutive process in which a polymer electrolyte membrane is directly formed using a polymer electrolyte doped with phosphoric acid is performed, a container for doping with phosphoric acid and a support roll for supporting the polymer electrolyte membrane need to be formed of an acid-resistance substance. Moreover, to increase the productivity of the polymer electrolyte membrane, several problems need to be addressed.

To address these problems, Muneuchi Atsuo et al., Fuel Cell Vol. 7 No. 2 (2007) 86 discloses a method of consecutively performing a process of synthesizing monomers constituting a polymer electrolyte and preparing a membrane electrode assembly (MEA) using a polymer electrolyte membrane doped with phosphoric acid. However, this method needs a large amount of equipment having resistance to acid. Further, it is necessary to set conditions such as hydrolysis of polyphosphoric acid used as a solvent by trial and error.

In addition, as an example of a polymer electrolyte membrane for a fuel cell that can be operated at 100° C. or more in a non-humidified environment, a molten salt electrolyte membrane has been disclosed besides the polymer electrolyte membrane doped with phosphoric acid described above (Hongjun Chen, et al., Electrochem. Comm., 9 (2007) 469). However, it is difficult to obtain sufficient power generation characteristics using this membrane.

In addition, as a method of using the above-described molten salt as a medium for transferring protons, a method of polymerizing a monomer in a molten salt (for example, Kamimura Toshiaki et al., 47th Battery Symposium Preview (2006) 178) or a method of forming an electrolyte membrane by a wet process using polymer electrolyte and a solution which is commercially available in a solution state (for example, Jeduck K I M et al., 47th Battery Symposium Preview (2006) 176) has been proposed. The method of obtaining such self-assembled membrane is considered to generally provide high productivity of the membrane, compared with the method of doping a polymer electrolyte membrane with phosphoric acid. However, in terms of characteristics of the electrolyte membrane itself, to obtain practical power generation characteristics, research and development of additional devices for proton conduction is needed.

In any kind of acid-doped electrolytes or molten salt-type electrolytes, a method of obtaining sufficient proton conductivity or power generation characteristics at a high temperature (i.e., 100° C.) or more in non-humidified conditions or a method of preparing an acid-doped electrolyte membrane with high productivity has not been proposed yet.

### SUMMARY

One or more embodiments include a polymer electrolyte membrane that is stable even at high temperatures in non-humidified conditions, thereby having high proton conductivity, a method of preparing a polymer electrolyte membrane, by which the polymer electrolyte membrane can be prepared with high productivity, and a fuel cell having high power generation characteristics by using the polymer electrolyte membrane.

According to aspects of the invention, a polymer electrolyte having an acidic functional group can be commonly used in a free acid, such as phosphoric acid and a polar organic solvent and accordingly, an acid-doped polymer electrolyte membrane can be formed using a wet membrane formation process.

To achieve the above and/or other aspects, one or more embodiments may include a method of preparing a polymer electrolyte membrane, having preparing a mixed solution, wherein the preparing of the mixed solution includes dissolving a polymer electrolyte having an acidic functional group and one free acid source selected from the group consisting of a free acid, mixtures of a free acid and Lewis acid, and mixtures of a free acid and an organic salt in a polar organic solvent and subjecting the mixed solution to wet membrane formation in order to prepare a polymer electrolyte membrane in which the polymer electrolyte is doped with the free acid.

The polymer electrolyte may include, as a main backbone, an aromatic engineering plastic. The aromatic engineering plastic may include polyethersulfone or polybenzimidazole.

The free acid may have an acidic inorganic phosphorus compound or an acidic organic phosphorus compound. The acidic inorganic phosphorus compound may have phosphoric acid, polyphosphoric acid, or phosphonic acid. The acidic organic phosphorus compound may include vinylphosphonic acid or ethylphosphonic acid.

The organic salt may include a quaternary ammonium cation.

The polar organic solvent may include an amide-based organic solvent.

The amide-based organic solvent may have dimethylacetamide, N-methyl-2-pyrrolidone, or dimethylformamide.

A molar number (nA) of the acidic functional group in the polymer electrolyte, a molar number (nB) of the free acid, and a molar number (nC) of the Lewis base may satisfy an inequality of nA+nB>nC.

The amount of the free acid dissolved in the polar organic solvent may be in the range of about 20 to about 80 parts by weight based on 100 parts by weight of the polymer electrolyte.

The free acid may have vinylphosphonic acid, and after the wet membrane formation, the vinylphosphonic acid doped in the polymer electrolyte may be polymerized. The mixed solution in which a multi-functional polymerizable compound is further dissolved in the polar organic solvent may be subjected to wet membrane formation, and after the wet membrane formation, the multi-functional polymerizable compound and the vinylphosphonic acid may be co-polymerized. The multi-functional polymerizable compound may include a multi-functional vinyl compound, diacrylate, or dimethacrylate.

To achieve the above and/or other aspects, one or more embodiments may include a polymer electrolyte membrane that has, as a main backbone, an aromatic engineering plastic having an acidic functional group, and is doped with a free acid including an acidic inorganic phosphorus compound or an acidic organic phosphorus compound.

The aromatic engineering plastic may include polyethersulfone or polybenzimidazole.

The acidic inorganic phosphorus compound may have phosphoric acid, polyphosphoric acid or phosphonic acid. The acidic organic phosphorus compound may include vinylphosphonic acid or ethylphosphonic acid.

To achieve the above and/or other aspects, one or more embodiments may include a fuel cell having a membrane electrode assembly using the polymer electrolyte membrane.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates Arrhenius plots showing the ionic conductivity of polymer electrolyte membranes prepared in Examples 1 through 5;

FIG. 2 illustrates an Arrhenius plot showing the ionic conductivity of a polymer electrolyte membrane prepared in Example 8;

FIG. 3 is a graph showing a polarization curve of a test fuel cell manufactured using a polymer electrolyte membrane prepared in Example 2; and

FIG. 4 is a graph showing a polarization curve of a test fuel cell manufactured using a polymer electrolyte membrane prepared in Example 3.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

As described above, it is difficult to directly obtain a conventional polymer electrolyte membrane doped with acid, such as phosphoric acid by a wet membrane formation. The reason is as follows in view of common knowledge, although not disclosed in documents. In general, a polymer material that can be doped with or retain acid (such as phosphoric acid) has a structure including a nitrogen-containing compound in a polymer backbone, as disclosed in Z. Zhou et al., J. Am. Chem. Soc. 127, (2005) 10825 and Y. Aihara et al., ECS Trans., 3 (2006) 123. In such polymer material, when the polymer itself is basic, it is considered that an acid used to dope the basic polymer (for example, polybenzimidazole (PBI)) interacts with the basic polymer, and the basic polymer can stably retain the acid to form a kind of a salt structure. Thus, when a polymer solution in which the polymer is dissolved in a solvent is mixed with acid although the polymer itself is dissolved in a solvent during wet membrane formation, an acid-base complex is directly formed by the base in the polymer solution and the mixed acid when the polymer is basic. The acid-base complex is insoluble in a solvent, and thus is precipitated in the polymer solution. In addition, the acid-base complex has insufficient formability, and thus it is very difficult to form a membrane using the acid-base complex itself.

In addition, the complexation of phosphoric acid and polymer has been reviewed a relatively long time ago. For example, G. Zukowska et al., Solid State Ionics, 119 (1999) 289 and G. Zukowska et al., Chem. Mater, 12 (2000) 3578 disclose that polyvinylidenefluoride or polyglycidylmethacrylate is used as a polymer backbone to form an electrolyte, and the electrolyte can provide a proton conductor. Such electrolyte can not tolerate high temperatures, as distinctly disclosed in G. Zukowska et al., Solid State Ionics, 119 (1999) 289 and G. Zukowska et al., Chem. Mater, 12 (2000) 3578, which describe material composition and temperature ranges for evaluating the material.

Moreover, all the polymer structures of such electrolytes do not include a basic unit, and thus it is possible to use a polymer electrolyte and acid together in a solvent. However, a polymer disclosed in G. Zukowska et al., Solid State Ionics, 119 (1999) 289 and G. Zukowska et al., Chem. Mater, 12 (2000) 3578, only retains the gel of DMF and phosphoric acid by using the polymer backbone, such as polyvinylidenefluoride or polyglycidylmethacrylate. In addition, there is no data disclosed in these documents on power generation characteristics when the polymer electrolyte is used in a fuel cell.

As described above, no acid-doped polymer electrolyte membranes with high productivity, which can be directly formed using a solution in which a polymer electrolyte is dissolved and no polymer electrolyte membranes which are stable at high temperatures in non-humidified conditions, thereby having high proton conductivity have been proposed. In addition, fuel cells using such acid-doped polymer electrolyte membranes, which are stable at high temperatures in non-humidified conditions, thereby having excellent power generation characteristics have not been proposed.

Thus, an experiment of directly preparing a polymer electrolyte membrane by wet membrane formation is provided, which is stable at high temperatures in non-humidified conditions, thereby having high proton conductivity. The experiment will now be described in detail.

### Preparation Conditions of Example Polymer Electrolyte Membrane

An experiment in which polyphosphoric acid was used as an acid for doping a polymer electrolyte and the solubility of the acid with respect to a basic polar organic solvent was evaluated will be described. In this experiment, polyphosphoric acid was dissolved in three kinds of polar organic solvents, i.e., N-methyl-2-pyrrolidone (NMP), dimethylacetamide (DMAc), and dimethylformamide (DMF) in amounts of 10 wt %, 20 wt %, 30 wt %, 40 wt %, and 50 wt %, respectively. The results are shown in Table 1 below.

In addition, in Table 1, ◯ denotes “soluble at room temperature (25° C.),” Δ denotes “soluble at 60° C.,” and x denotes “insoluble.”

TABLE 1

| | NMP | DMAc | DMF |
|---|---|---|---|
| 10 wt % | ∘ | x | ∘ |
| 20 wt % | ∘ | x | ∘ |
| 30 wt % | Δ | x | Δ |
| 40 wt % | x | x | x |
| 50 wt % | x | x | x |

As shown in Table 1, 20 wt % of polyphosphoric acid is soluble in NMP and DMF at room temperature, and 30 wt % of polyphosphoric acid is soluble in NMP and DMF at 60° C. On the other hand, even 10 wt % of polyphosphoric acid is insoluble in DMAc. From the results, it can be seen that polyphosphoric acid may be dissolved using NMP or DMF as a polar organic solvent.

Next, an experiment was performed such that a polymer with a sulfonic acid group was used as a polymer electrolyte with an acidic functional group. The solubility of the polymer with the sulfonic acid group with respect to a basic polar organic solvent was evaluated will now be described. In this experiment, the same polar organic solvents as used to dissolve the polyphosphoric acid were used, and sulfonated polyetheretherketone as the polymer with a sulfonic acid group is respectively dissolved in the polar organic solvents. The amounts of the polymer with a sulfonic acid group added to the polar organic solvents are 10 wt %, 20 wt %, 30 wt %, 40 wt %, and 50 wt %. The results are shown in Table 2 below. In Table 2, ◯ denotes “soluble,” x denotes “insoluble,” and Δ denotes “soluble, but can not be stirred due to very high viscosity.”

TABLE 2

| | NMP | DMAc | DMF |
|---|---|---|---|
| 10 wt % | ∘ | ∘ | ∘ |
| 20 wt % | ∘ | ∘ | ∘ |
| 30 wt % | Δ | ∘ | Δ |
| 40 wt % | Δ | Δ | x |
| 50 wt % | x | x | x |

As shown in Table 2, 10 to 40 wt % of the polymer with a sulfonic acid group is soluble in NMP, but 30 to 40 wt % thereof has a high viscosity. In addition, 10 to 40 wt % of the polymer with a sulfonic acid group is soluble in DMAc, but 40 wt % thereof has a high viscosity. In addition, 10 to 30 wt % of the polymer with a sulfonic acid group is soluble in DMF, but 30 wt % thereof has a high viscosity. From the results, it can be seen that a polymer electrolyte may be dissolved using DMAc or NMP as a polar organic solvent, and in particular, DMAc.

However, to form a polymer electrolyte membrane that is directly doped with acid by wet membrane formation, both the polymer electrolyte and the acid used to dope the polymer electrolyte need to be dissolved in the polar organic solvent. Since polyphosphoric acid is insoluble in DMAc as shown in Table 1, NMP may be used as the polar organic solvent in order to dissolve both the polyphosphoric acid and the polymer electrolyte with a sulfonic acid group.

After the results described above were obtained, the present inventors found that polyphosphoric acid can be dissolved in DMAc that dissolves the polymer electrolyte with a sulfonic acid group. Hereinafter, a method of preparing a polymer electrolyte membrane, a polymer electrolyte membrane obtained using the method, and a fuel cell using the polymer electrolyte membrane according to aspects of the invention will be described in more detail.

According to an embodiment, a mixed solution includes a polymer electrolyte having an acidic functional group and a free acid source which are dissolved in a polar organic solvent. The mixed solution is subjected to wet membrane formation to obtain a polymer electrolyte membrane in which the polymer electrolyte is doped with the free acid. In particular, the method of preparing a polymer electrolyte membrane is performed largely using four processes below. However, it is understood that the method is not specifically limited to the below processes or the order in which they are shown below.
(1) Solution preparation process
(2) Membrane formation process
(3) Pre-drying process
(4) Drying process

The solution preparation process according to an aspect of the invention will be described. In this process, the polymer electrolyte having an acidic functional group (for example, a polymer compound having a sulfonic acid group) and the free acid (for example, polyphosphoric acid) are dissolved in the polar organic solvent to prepare the mixed solution. The mixed solution is prepared by adding the polymer electrolyte having an acidic functional group and the free acid to the polar organic solvent and stirring the mixture using a mechanical stirrer or a magnetic stirrer. The stirrer used is not limited to a mechanical stirrer or a magnetic stirrer, and may be any stirrer which can fully mix and dissolve the polymer electrolyte and the free acid in the polar organic solvent. In addition, bubbles may occur due to stirring when the mixed solution is prepared. Thus the mixed solution may be defoamed by vacuum defoaming or centrifugal defoaming when stirred.

Hereinafter, materials used in preparing the mixed solution according to examples and aspects of the invention will be described in detail.

The polymer electrolyte having an acidic functional group, used in the solution preparation process described above, is not particularly limited, and may have a structure in which a main backbone is an aromatic engineering plastic, taking into consideration compatibility with the acid that dopes the polymer electrolyte in the polar organic solvent, or processibility and heat resistance during membrane formation. The aromatic engineering plastic is not particularly limited as long as it is an aromatic engineering plastic. For example, the aromatic engineering plastic may be aromatic engineering plastics having a sulfonic acid group as the acidic functional group, such as polyethersulfone, sulfonated polybenzimidazole, sulfonated polyetheretherketone, sulfonated polysulfone, sulfonated polypenyleneoxide, sulfonated aromatic polyimide, sulfonated aromatic polyamide, sulfonated polycarbonate, sulfonated polyethyleneterephthalate, sulfonated polyarylate, or sulfonated polyetherimide.

In addition, the acidic functional group may be, in addition to the sulfonic acid group, a phosphoric acid group, a phosphonic acid group, a carboxylic acid group, or a sulfonylamide group, and specifically, a sulfonic acid group, a phosphoric acid group, or a phosphonic acid group.

The term “free acid source” used herein refers to a free acid, a mixture of a free acid and a Lewis base, or a mixture of a free acid and an organic salt. The free acid is not particularly limited, and may be phosphoric acid, phosphonic acid, phosphinic acid, sulfuric acid, methylsulfonic acid, trifluoromethylsulfonic acid, or trifluoromethanesulfonylamidesulfonic acid according to aspects of the invention. In particular, in terms of thermal stability, the free acid may be an acidic inorganic phosphorus compound or an acidic organic phosphorus compound. The acidic inorganic phosphorus compound may be phosphoric acid, polyphosphoric acid, phosphonic acid, or phosphinic acid, and specifically, phosphoric acid, polyphosphoric acid, or phosphonic acid.

The acidic organic phosphorus compound may be allylphosphonic acid, such as vinylphosphonic acid; alkylphosphonic acid, such as methylphosphonic acid or ethylphosphonic acid; or acidic phosphoric acid ester, such as methylphosphoric acid ester, ethylphosphoric acid ester, or butylphosphoric acid ester. Specifically, the acidic organic phosphorus compound may be vinylphosphonic acid or ethylphosphonic acid.

In addition, the Lewis base that can be mixed with the free acid may be an azole-based compound such as imidazole, triazole, benzimidazole, or benzotriazole; a nitrogen-containing six-membered heterocyclic compounds such as pyridine, pyridazine, pyrimidine, pyradinzine, or triazine; a nitrogen-containing polycyclic condensed heterocyclic compound such as quinoline, quinoxaline, indole, or phenazine; or a nucleic acid base such as purine, uracil, thymine, cytosine, adenine, or guanine.

In addition, the organic salt that can be mixed with the free acid may be a neutral salt comprising an organic compound cation and an oxo-acid anion. The organic compound cation may be cations of common heterocyclic compounds, in particular, cations of three- to six-membered ring heterocyclic compounds containing 1 to 5 hetero atoms, and more particularly, cations of three- to six-membered ring compounds containing 1 to 5 nitrogen atoms as the hetero atom. More specifically, the organic compound cation may be imidazolium cations, piperidinium cations, or pyridinium cations. Also, chain-type quaternary ammonium cations or quaternary phosphonium cations may be used.

In particular, the organic compound cation may be imidozolium cations or chain-type quaternary ammonium cations, specifically a 1,3-substituted imidazolium cation, and more specifically, an imidazolium cation represented by Formula 1 below:

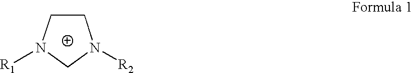

R₁ is a C₁-C₆ alkyl group, and R₂ is a C₁-C₃₀ alkyl group. R₂ may be a C₁-C₂₅ alkyl group, particularly a C₁-C₂₀ alkyl group, and more particular, a C₁-C₁₆ alkyl group.

The imidazolium cation of Formula 1 may be a 1,3-dimethylimidazolium cation, a 1-ethyl-3-methylimidazolium cation, a 1-methyl-3-propylimidazolium cation, a 1-butyl-3-methylimidazolium cation, a 1-methyl-3-pentylimidazolium cation, a 1-hexyl-3-methylimidazolium cation, a 1-heptyl-3-methylimidazolium cation, a 1-methyl-3-octylimidazolium cation, a 1-decyl-3-methylimidazolium cation, a 1-dodecyl-3-methylimidazolium cation, a 1-ethyl-3-propylimidazolium cation, or a 1-butyl-3-ethylimidazolium cation.

That is, the organic salt may be 1,3-dimethylimidazolium dihydrogenphosphite (DMIP), 1-butyl-3-methylimidazolium dihydrogenphosphite (BMIP), 1-hexyl-3-methylimidazolium dihydrogenphosphite (HMIP), 1-methyl-3-octylimidazolium dihydrogenphosphite (MOIP), 1-dodecyl-3-methylimidazolium dihydrogenphosphite (C12MIP), 1-hexadecyl-3-methylimidazolium dihydrogenphosphite (C16MIP), or 1-dodecyl-3-methylimidazolium hydrogensulfite (C12MIS).

According to aspects of the invention, the polar organic solvent used in the solution preparation process may be a nitrogen-containing amide-based organic solvent, taking into consideration the compatibility between the polymer electrolyte having an acidic functional group and the acid used to dope the polymer electrolyte. The amide-based organic solvent may be formamide, N-methylformamide, N,N-dimethylformamide, N-methylacetamide, N,N-dimethylacetamide, N-methylpropioamide, 2-pyrrolidinone, or N-methylpyrrolidone. Specifically, the amide-based organic solvent may be dimethylacetamide, N-methyl-2-pyrrolidone, or dimethylformamide.

When the polymer electrolyte and the mixture of the free acid and Lewis base are added to the polar organic solvent, a molar number (nA) of the acidic functional group in the polymer electrolyte, a molar number (nB) of the free acid, and a molar number (nC) of the Lewis base may satisfy an inequality of nA+nB>nC. This requirement is needed to produce protons as a carrier of charges by inclining the pH of the mixed solution to be acidic.

In addition, in the solution preparation process, the amount of the free acid may be in the range of about 20 to about 80 parts by weight based on 100 parts by weight of the polymer electrolyte. The mixing ratio of the polymer electrolyte and the free acid is determined based on Examples which will be described later, and thus will be described later in detail.

The membrane formation process according to an aspect of the invention will be described. In this process, a free-acid doped polymer electrolyte membrane is directly formed using the mixed solution prepared in the solution preparation process by wet membrane formation. In particular, the mixed solution prepared in the solution preparation process is cast on a base using a known coating method to prepare the polymer electrolyte membrane. The coating process may be performed using, for example, a die coater, a COMMA COATER (registered trade mark), a doctor blade, or an application roll. The base on which the mixed solution is cast may be, for example, poly(ethyleneterephthalate) or polyimide (glass).

The pre-drying process according to an aspect of the invention will now be described. In this process, the polymer electrolyte membrane that is cast on the base in the membrane formation process may be dried at a temperature of about 40 to about 80° C. and for example, at about 60° C. for at least 10 minutes (no blower). The pre-drying process is performed to form the polymer electrolyte membrane by using the mixed solution and also to remove remainders of the polar organic solvent included in the polymer electrolyte membrane. According to an embodiment, a hot plate is used as a drying device, and in no blowing conditions without a blower, the surface of the polymer electrolyte membrane can be formed in the pre-drying process at 60° C. in about 10 minutes, the polymer electrolyte membrane can be detached from the base in the pre-drying process at 60° C. in about 20 minutes, and 80 wt % or more of the polar organic solvent can volatilize in the pre-drying process at 60° C. in about 40 minutes. Thus, the process can last at least 40 minutes, where after the first 10 minutes, another 10 minutes allows the polymer electrolyte membrane to detach from the base, and a further 20 minutes allows the polar organic solvent to volatize. In this regard, if the drying temperature is too high such that the pre-drying process is performed too quickly, the polar organic solvent in bulk can not be easily volatilized from the polymer electrolyte membrane. As a result, defects may occur or cause wrinkles or stress relaxation in the polymer electrolyte membrane. On the other hand, if the drying temperature is too low, it takes a long time for the drying process, and thus the productivity of the polymer electrolyte membrane is too low. Due to these reasons, the pre-drying process is determined to be performed at a temperature of about 40 to about 80° C. (for example, about 60° C.) for at least 10 minutes (no blower). For example, the pre-drying process can be for 20 minutes or more to have the membrane be detached. Where the membrane and the polar organic solvent is to volatize, the pre-drying process can, for example, be about 40 minutes.

The drying process according to an aspect of the invention will be described. In the drying process (hereinafter, also referred to as “main drying”), the pre-dried polymer electrolyte membrane in the pre-drying process is dried at a temperature of about 110° C. to about 150° C. (for example, 110-130° C.) for at least 20 minutes (no blower). The drying process is performed to remove moisture included in the polymer electrolyte membrane or the polar organic solvent. According to an embodiment, an oven is used as a drying device, and when no blowing conditions exist (i.e., no blower) when the drying process is performed at no less than 110° C. to 150° C. or less for 20 minutes or longer, the moisture included in the polymer electrolyte membrane or the polar organic solvent is volatilized. Thus, the drying process is determined to be performed at a temperature of about 110° C. to about 150° C. for at least 20 minutes.

A conventional batch process includes forming a polymer electrolyte membrane in the form of a film, and then doping the polymer electrolyte membrane with a free acid. In this process, the polymer electrolyte membrane absorbs a large amount of the free acid, and thus the acid is free on the surface of the polymer electrolyte membrane. In addition, unless the polymer electrolyte membrane is doped with a large amount of the acid to an equilibrium swelling state in which swelling acid reaches an equilibrium state, the proton conductivity is insufficient. Thus, the polymer electrolyte membrane needs to be immersed in the acid for a long period of time. As a result, the productivity of the polymer electrolyte membrane decreases and the mechanical strength thereof is also decreased.

In addition, in the method of preparing a polymer electrolyte membrane according to the embodiment, the polymer and the free acid are dissolved together in the polar organic solvent, and a film can be formed using a cast method. Thus, a polymer electrolyte membrane that is uniformly doped with the acid can be directly obtained after the formation of the film. Accordingly, in the method of preparing a polymer electrolyte membrane according to the present embodiment, the productivity of the acid-doped polymer electrolyte membrane may be improved. In addition, the polymer used is a polymer having an acidic functional group (for example, sulfonic acid group), and the acidic functional group contributes to the proton conduction. In addition, due to the weak interaction between the doping acid and the acidic functional group of the polymer, a polymer electrolyte membrane with high proton conductivity is obtained even at a low acid doping rate. Since the acid doping rate can be adjusted to be low, the polymer does not need to be doped with the acid to the equilibrium swelling state. Therefore, the polymer electrolyte membrane prepared using the method according to the present embodiment can have high mechanical strength.

In the method of preparing a polymer electrolyte membrane according to an embodiment, if vinylphosphonic acid is used as the free acid, the formed polymer electrolyte membrane may be semi-solidified by secondary processing. That is, the vinylphosphonic acid used to dope the polymer electrolyte membrane after the membrane formation process is polymerized, thereby improving the strength of the polymer electrolyte membrane. Accordingly, the formed polymer electrolyte membrane may have improved mechanical strength. The vinylphosphonic acid may be polymerized.

While not limited thereto, the polymerization can be by, for example, irradiating UV light, β-rays, γ-rays, electron beams, or combinations thereof to the formed polymer electrolyte membrane in the form of a film, or by using a polymerization initiator. However, the polymerization method of the vinylphosphonic acid is not limited thereto. Examples of the polymerization initiator include an azo-based polymerization initiator, such as azobisisobutyronitrile and dimethyl 2,2′-azoisobutylate, a peroxide-based polymerization initiator, such as benzoylperoxide and di-t-butylperoxide, a living radical polymerization initiator, such as 2,2,6,6-tetrapiperidinyloxyl, and a photo-initiator in polymerization by UV light, such as Irgacure 651, 184, 369.

In addition, in the solution preparation process described above, a multi-functional polymerizable compound, in addition to the polymer electrolyte and the free acid, source is dissolved in the polar organic solvent to prepare a mixed solution, and the mixed solution is subjected to wet membrane formation. Then, the multi-functional polymerizable compound may be co-polymerized with vinylphosphonic acid. By co-polymerizing the multi-functional polymerizable compound and the vinylphosphonic acid, water-soluble components of the vinylphosphonic acid can be reduced, and the mechanical strength of the formed polymer electrolyte membrane can also be increased. Accordingly, an increase in the internal resistance of a fuel cell, caused by leakage of acid components to product water during power generation, is inhibited. As a result, a fuel cell including the polymer electrolyte membrane described above can operate for a long period of time. The vinylphosphonic acid may be polymerized by, for example, irradiating UV light, β-rays, γ-rays, electron beams, or combinations thereof to the formed polymer electrolyte membrane in the form of a film, or by using a polymerization initiator. Examples of the multi-functional polymerizable compound include a multi-functional vinyl compound, such as divinylbenzene, divinylphenylphosphine, and divinylsiloxane; and a multi-functional acrylate compound, such as triethyleneglycol diacrylate, trimethylolpropane triacrylate, pentaerythritol tetraacrylate, and triethyleneglycol di methacrylate.

Structure of Polymer Electrolyte Membrane

The method of preparing a polymer electrolyte membrane according to an embodiment has been described in detail, and a structure of the polymer electrolyte membrane will now be described. The polymer electrolyte membrane comprises, as a main backbone, an aromatic engineering plastic having an acidic functional group, and is doped with a free acid comprising an acidic inorganic phosphorus compound or an acidic organic phosphorus compound. In this regard, a detailed description of the aromatic engineering plastic, the acidic inorganic phosphorus compound, and the acidic organic phosphorus compound is described as above, and thus is not provided herein.

According to the polymer electrolyte membrane described above, the polymer having an acidic functional group (for example, sulfonic acid group) is used as a polymer that is a main backbone of the polymer electrolyte membrane, and the acidic functional group contributes to the proton conduction. In addition, due to a weak interaction between the doping acid and the acidic functional group of the polymer, a polymer electrolyte membrane with high proton conductivity may be obtained even at a low acid doping rate. Moreover, since the acid doping rate can be adjusted to be low, the polymer does not need to be doped with the acid to an equilibrium swelling state. Therefore, the polymer electrolyte membrane can have high mechanical strength.

In addition, when vinylphosphonic acid is used as the free acid, and the vinylphosphonic acid is polymerized after the membrane formation, the vinylphosphonic acid doped in the polymer electrolyte using the aromatic engineering plastic as a main backbone is polymerized, thereby improving the mechanical strength of the polymer electrolyte membrane. In addition, when the multi-functional polymerizable compound is co-polymerized with vinylphosphonic acid, the mechanical strength of the polymer electrolyte membrane is increased, the water-soluble components of the vinylphosphonic acid can be reduced, and the leakage of acid components to product water during power generation can be prevented, and as a result, a fuel cell including the polymer electrolyte membrane can operate for a long period of time.

Fuel Cell

A fuel cell according to an embodiment includes a membrane electrode assembly (MEA) using the polymer electrolyte membrane described above. The polymer electrolyte membrane is stable at a high temperature (i.e., about 150° C.) in non-humidified conditions. Thus, it has high proton conductivity and mechanical strength. Further, the fuel cell using the polymer electrolyte membrane has excellent power generation characteristics, such as electromotive force characteristics, current-voltage characteristics, and fuel cell lifespan.

The fuel cell may be manufactured using the polymer electrolyte membrane preparing using the method described above by using a known method. That is, for example, in a PEFC, an electrode (comprising a catalyst layer and a gas diffusion layer) is formed on both surfaces of the polymer electrolyte membrane to prepare a membrane electrode assembly (MEA). Then, the MEA is interposed between a pair of separators (such as metal separators) to fabricate a unit cell. A plurality of such unit cells are stacked to manufacture a fuel cell stack.

Hereinafter, one or more embodiments will be described more specifically with reference to the following examples. The following examples are for illustrative purposes only and are not intended to limit the scope of the invention.

Experiment on Mixing Ratio of Polymer Electrolyte and Free Acid

First, an experiment in which a polymer electrolyte and a free acid were mixed using different mixing ratios, performed by the present inventors, will be described.

### Experimental Example 1

Sulfonated polyetheretherketone as a sulfonated polymer, polyphosphoric acid (PPA) as a free acid, and DMAc as a polar organic solvent were used. When the amount of PPA was in the range of 20 to 160 parts by weight based on 100 parts by weight of the sulfonated polymer, the amount range of PPA in order to prepare a uniform mixed solution was determined, and the results are shown in Table 3 below.

As described above, PPA is generally insoluble in DMAc, but PPA is soluble in DMAc in which the sulfonated polymer is dissolved.

TABLE 3

| PPA | | | |
|---|---|---|---|
| (parts | DMAc | | |
| by | solution | PPA | |
| weight) | (g) | (g) | State of solution |
| 20 | 1.6 | 0.064 | Uniform, transparent light brown |
| 40 | 4.6 | 0.128 | Uniform, little milky white light brown |
| 60 | 1.6 | 0.192 | Uniform, little milky white light brown |
| 80 | 1.6 | 0.256 | Uniform, |
| 100 | 1.6 | 0.32 | Separated as two layers, white solution with |
| | | | high viscosity precipitated, light brown fluidic |
| | | | liquid as a supernatant |
| 120 | 1.6 | 0.384 | Separated as two layers, milky white liquid |
| | | | with high viscosity in entire solution, light |
| | | | brown fluidic liquid as a supernatant |
| 140 | 1.6 | 0.448 | PPA insoluble, white solid precipitated, high |
| | | | viscosity |
| 160 | 1.6 | 0.512 | PPA insoluble, white solid precipitated, very |
| | | | high viscosity |

In Table 3, the amount (parts by weight) of PPA added with respect to the polymer, the amounts (g) of DMAc and PPA, and the state of the mixed solutions after preparation are shown. To form a uniform polymer electrolyte membrane, it is necessary to obtain a uniform mixed solution. To obtain the uniform mixed solution, as shown in Table 3, the amount of PPA with respect to the sulfonated polymer may be in the range of 20 to 80 parts by weight, and preferably, 80 parts by weight.

In addition, the mixed solutions prepared as described above were subjected to membrane formation using a cast method, and the results are shown in Table 4 below. The polymer electrolyte membranes were prepared by casting about 0.5 cm³ of each of the prepared mixed solutions on a substrate and drying the resultant. The drying process was performed in an oven at a temperature of 120° C. for 30 minutes after a pre-drying process was performed on a hot plate at a temperature of 60° C. for 1 hour.

TABLE 4

| PPA (parts | Membrane | |
|---|---|---|
| by weight) | thickness (μm) | State of membrane |
| 20 | 58 | White, two types of spots uniformly |
| | | dispersed |
| 40 | 73 | White, two types of spots uniformly |
| | | dispersed |
| 60 | 89 | White, spots existed |
| 80 | 118 | White and uniform |
| 100 | 150 | White, lots of traces of bubbles, very large |
| | | leakage of phosphoric acid |
| 120 | 130 | White, lots of traces of bubbles, very large |
| | | leakage of phosphoric acid |

In Table 4, the amount (parts by weight) of PPA with respect to the polymer, the thickness of the obtained polymer electrolyte membranes, and the state of the membranes are shown. As shown in Table 4, when the amount of PPA with respect to the sulfonated polymer is in the range of 20 to 80 parts by weight, no leakage of phosphoric acid to the outside occurs. In particular, when the amount of PPA with respect to the sulfonated polymer is 80 parts by weight, a uniform polymer electrolyte membrane is obtained.

### Experimental Example 2

The amount range of PPA in order to prepare a uniform mixed solution was determined in the same manner as in Experimental Example 1, except that NMP was used as the polar organic solvent. The results are shown in Table 5 below.

TABLE 5

| PPA | NMP | | |
|---|---|---|---|
| (parts by | solution | | |
| weight) | (g) | PPA (g) | State of solution |
| 20 | 1.6 | 0.064 | Uniform, transparent light brown |
| 40 | 1.6 | 0.128 | Uniform, transparent light brown |
| 60 | 1.6 | 0.192 | Uniform, transparent light brown, |
| | | | high viscosity |
| 80 | 1.6 | 0.256 | Uniform, milky white light brown, |
| | | | high viscosity |
| 100 | 1.6 | 0.32 | Uniform, milky white light brown, very |
| | | | high viscosity, poor fluidic characteristics |
| 120 | 1.6 | 0.384 | PPA insoluble, white solid precipitated, |
| | | | hardened in jelly form |
| 140 | 1.6 | 0.448 | PPA insoluble, white solid precipitated, |
| | | | hardened in jelly form |
| 160 | 1.6 | 0.512 | PPA insoluble, white solid precipitated, |
| | | | hardened in jelly form |

In Table 5, the amount (parts by weight) of PPA with respect to the polymer, the amounts (g) of NMP and PPA, and the state of the mixed solutions after preparation are shown.

As shown in Table 5, in order to obtain a uniform mixed solution, the amount of PPA may be in the range of about 20 to about 80 parts by weight based on 100 parts by weight of the polymer electrolyte.

In addition, when the amount of PPA is 100 parts by weight based on 100 parts by weight of the polymer electrolyte, a uniform mixed solution can be obtained. However, the viscosity of the solution is very high, and thus the solution has very poor fluidic characteristics. Accordingly, it is difficult to cast the solution on a substrate. Thus, while 100 parts may be possible, in order to obtain a uniform polymer electrolyte membrane, the amount of PPA may be 80 parts by weight or less based on 100 parts by weight of the polymer electrolyte. In addition, the greater the amount of PPA, the better the proton conductivity, but when the amount of PPA is greater than 120 parts by weight, it is not easy to cast the solution on a substrate.

As can be seen from the results shown in Table 3 and Table 5 above, the mixing ratio of PPA to the sulfonated polymer when DMAc is used is almost the same as that when NMP is used, wherein DMAc and NMP have a different solubility with respect to PPA.

In addition, the prepared mixed solutions were subjected to membrane formation using a cast method as in Experimental Example 1, and the results are shown in Table 6 below. As shown in Table 6, when the amount of PPA with respect to the sulfonated polymer was in the range of 20 to 80 parts by weight, no leakage of phosphoric acid to the outside (of the sulfonated polymer) occurred. In addition, when the amount of PPA was 80 parts by weight, a uniform polymer electrolyte membrane was obtained.

TABLE 6

| PPA (parts | Membrane | |
|---|---|---|
| by weight) | thickness (μm) | State of membrane |
| 20 | 70 | White, entirely uniform |
| 40 | 98 | Yellow-colored white, entirely uniform |
| 60 | 101 | Yellow-colored white, entirely uniform |
| 80 | 48 | Yellow-colored white, little non-uniform in |
| | | edge portion |
| 100 | 120 | Yellow-colored white, traces of bubbles |
| | | existed, stain in thickness (in membrane), |
| | | leakage occurs |

Experiment on Pre-Drying Time

An experiment on the drying time in the pre-drying process, performed by the present inventors, will now be described.

### Experimental Example 3

A mixed solution (in this regard, a mixed solution in which PPA was added to a DMAc solution in which 20 wt % of sulfonated polyetheretherketone (S-PEEK) as a polymer was dissolved in DMAc, such that the amount of PPA was 60 wt % with respect to the weight of the polymer) was cast on a polyimide glass substrate. The cast solution was dried on a hot stirrer, and the volatilization amount of the solvent was measured. The volatilization amount of the solvent was obtained by measuring the amount of a change (decrease) in the weight of the membrane at drying times of 10, 20, 30, 40, 50 and 60 minutes, respectively. The amount of the volatilized solvent is represented by a ratio of the amount of the change in the weight of the membrane with respect to the weight of the membrane before drying. The present experiment was performed without a blower in non-blowing conditions. The results are shown in Table 7 below.

TABLE 7

| Drying time | Membrane | Amount of | Rate of volatilized solvent |
|---|---|---|---|
| (min) | weight (mg) | change (mg) | (mass %) |
| 0 | 719.75 | 0 | — |
| 10 | 438.88 | −280.87 | 54.6 surface of membrane |
| | | | formed |
| 20 | 351.13 | −368.62 | 71.7 membrane could be |
| | | | detached from substrate |
| 30 | 323.24 | −396.51 | 77.1 |
| 40 | 305.43 | −414.32 | 80.6 |
| 50 | 301.80 | −417.95 | 81.3 |
| 60 | 297.91 | −421.84 | 82.1 |

As shown in Table 7, when the drying time passed 10 minutes, a surface of the polymer electrolyte membrane was formed, and when the drying time passed 20 minutes, the polymer electrolyte membrane could be detached from the glass substrate. That is, it was necessary to dry the mixed solution cast on the glass substrate at a temperature of 60° C. for at least 10 minutes and to perform subsequent processes (i.e., the main drying process) on the resultant. In addition, when a base on which the mixed solution was cast was detached after the pre-drying process, and then both surfaces of the polymer electrolyte membrane were dried by wind from a blower, the pre-drying time was required to be at least 20 minutes. On the other hand, when the main drying process was performed on the mixed solution with a base attached thereto (white film), the pre-drying time was required to be about 10 minutes.

Experiment on Main Drying Temperature

An experiment on the drying temperature in a main drying process after the pre-drying process, will now be described.

### Experimental Example 4

The impact of drying temperature on a mixed solution cast on a polyimide glass substrate (in this regard, a mixed solution in which PPA was added to a DMAc solution in which 20 wt % of sulfonated polyetheretherketone (S-PEEK) as a polymer was dissolved in DMAc, such that the amount of PPA was 60 wt % with respect to the weight of the polymer) was evaluated. In addition, in order for the polymer electrolyte membrane not to be affected by the pre-drying time, the pre-drying process was performed at a temperature of 60° C. for 1 hour, and then the main drying process was performed for 20 minutes at temperatures of 110° C., 130° C., 150° C. and 170° C., respectively. The results are shown in Table 8 below.

TABLE 8

| | Weight (mg) | | | Properties and states | |
|---|---|---|---|---|---|
| | after | After | Amount | After | After |
| | drying at | drying in | of | drying | drying |
| | 60° C. | oven | change | at 60° C. | in oven |
| 110° C. | 523.72 | 434.23 | −89.49 | white, transparent | No change in color and |
| | | | | spots uniformly | strength, very slightly |
| | | | | distributed, strength as | humidified |
| | | | | freely as handling | Membrane thickness t = 78 μm |
| | | | | membrane using | |
| | | | | tweezers, easy | |
| | | | | handling | |
| 130° C. | 574.53 | 446.29 | −128.24 | As above | color change to very light |
| | | | | | brown, ambient condition |
| | | | | | and surface of membrane |
| | | | | | are so dry that membrane |
| | | | | | is smooth, strength |
| | | | | | increases a little bit |
| | | | | | membrane thickness t = 76 μm |
| 150° C. | 498.69 | 369.95 | −128.74 | As above | Color change to light |
| | | | | | brown, strength increases |
| | | | | | membrane thickness t = 64 μm |
| 170° C. | 612.62 | 423.37 | −189.25 | As above | Color change to brown, so |
| | | | | | dry that membrane |
| | | | | | contracted, very hard |
| | | | | | membrane |
| | | | | | membrane thickness t = 69 μm |

As shown in Table 8, the surface of the polymer electrolyte membrane was very slightly humidified at a drying temperature of 110° C. due to the impacts of the doped phosphoric acid and polar organic solvent, but the surface thereof was fully dried at a drying temperature greater than 130° C. In addition, the weight of the membrane changed according to dehydration of the phosphoric acid at a drying temperature greater than 150° C. Thus, the drying temperature may be in the range of about no less than 110° C. to less than about 150° C. In addition, the membrane turned a little brown at a drying temperature of 130° C. or more. The color change is attributed to dehydration of absorbed water around sulfonic acid and since phosphoric acid dominantly contributes to proton conduction. Such color change rarely affects performance, such as proton conductivity of the polymer electrolyte membrane.

Experiment on Main Drying Temperature and Time

An experiment on drying temperature and drying time in a main drying process after the pre-drying process, will now be described.

### Experimental Example 5

Impacts of drying temperature and drying time on a mixed solution cast on a polyimide glass substrate (in this regard, a mixed solution in which PPA was added to a DMAc solution in which 20 wt % of sulfonated polyetheretherketone (S-PEEK) as a polymer was dissolved in DMAc, such that the amount of PPA was 60 wt % with respect to the weight of the polymer) were evaluated. In addition, the pre-drying process was performed on the polymer electrolyte membrane at a temperature of 60° C. for 20 minutes, and then the main drying process was performed on the polymer electrolyte membrane at drying temperatures of 110° C., 130° C., 150° C. and 170° C. for drying times of 20, 40, 60 and 80 minutes, respectively. The results are shown in Table 9 below.

TABLE 9

Change in weight (%)

| | 110° C. | 130° C. | 150° C. | 170° C. |
|---|---|---|---|---|
| 0 min | 0 | 0 | 0 | 0 |
| 20 min | −11.26 | −12.76 | −9.16 | −10.91 |
| 40 min | −12.56 | −22.79 | −11.82 | −13.95 |
| 60 min | −17.43 | −26.81 | −13.79 | −15.52 |
| 80 min | −16.52 | −29.8 | −15.61 | −15.77 |

As shown in Table 9, the weight of the polymer electrolyte membrane is decreased by up to about 10% when the drying process was performed for 20 minutes in all the temperature ranges. That is, 80% of more of the solvent could be removed during the pre-drying and main drying processes. In addition, as can be seen in Table 9, the impact of the drying temperature on the removal amount of the solvent is relatively low, and a change in the removal amount of the solvent according to the drying time is large. In addition, in practical preparation of the polymer electrolyte membrane, a mixed solution is printed (cast) on PET as a base using a roll and dried, and in this regard, the drying temperature may be 150° C. or less. Moreover, even when the drying process is performed for a drying time of 20 minutes or more, the amount of a change in the weight of the polymer electrolyte membrane does not change much. Thus, a drying time of about 20 minutes is enough. Further, even with a long drying time, the removal amount of moisture or solvent also increases, and thus a drying time of greater than 20 minutes does not matter in terms of the productivity of the polymer electrolyte membrane.

Impact of Amount of Added Free Acid on Ionic Conductivity

Experiment on the impact of the added free acid on ionic conductivity will now be described.

### Experimental Example 6

Polymer electrolyte membranes were prepared using a mixed solution in which sulfonated polyetheretherketone (S-PEEK) as a polymer having an acidic functional group and PPA as a free acid were dissolved in DMAc as a polar organic solvent and using a mixed solution in which S-PEEK and PPA were dissolved in NMP as a polar organic solvent, and the ionic conductivity of each polymer electrolyte membrane was measured at 130° C. The ionic conductivity was measured as follows: each polymer electrolyte membrane was cut in the form of a circle of 13 mmφ, inserted into a two-electrode platinum blocking electrode cell having a TEFLON (registered trade mark) housing, and the resultant cell was fixed in a thermostat. The temperature of the thermostat was raised to 150° C. and the resultant was left sit for one day. Then the resistance of the cell was measured at a constant temperature of 150° C. The resistance of the cell was measured using a SI1287 Electrochemical Interface and SI1260 Impedance/gain phase Analyzer manufactured by Solartron, United Kingdom. The ionic conductivity of the polymer electrolyte membrane was calculated from the obtained bulk resistance and cell constant. The results are shown in Table 10. In Table 10, PPA20 through PA80 respectively represent the amount of PPA added with respect to polymer. For example, PPA20 represents that 20 parts by weight of PPA with respect to 100 parts by weight of the polymer exists in the polymer electrolyte membrane.

TABLE 10

| | Conductivity of membrane | Conductivity of membrane |
|---|---|---|
| | prepared using DMAc (S/cm) | prepared using NMP (S/cm) |
| PPA20 | 1.90E−03 | 2.56E−03 |
| PPA40 | 5.37E−03 | 3.25E−03 |
| PPA60 | 1.20E−02 | 1.00E−02 |
| PPA80 | 2.50E−03 | 6.03E−03 |

As shown in Table 10, when the amount of PPA added is in the range of 20 to 80 parts by weight based on 100 parts by weight of the polymer, the proton conductivities of all the polymer electrolyte membranes are good. In addition, regardless of the type of the polar organic solvent, the proton conductivity of each polymer electrolyte membrane increases when the amount of PPA is in the range of 20 to 60 parts by weight, is in a peak state when the amount of PPA is 60 parts by weight, and decreases slightly when the amount of PPA is 80 parts by weight. From the results, it can be seen that the amount of free acid, such as PPA added may be in the range of 20 to 80 parts by weight, specifically in the range of 40 to 80 parts by weight, and more specifically, 60 parts by weight based on 100 parts by weight of the polymer.

Evaluation on Physical Properties of Polymer Electrolyte Membrane

Three types of polymer electrolytes were synthesized using the following method to prepare polymer electrolyte membranes. The proton conductivity of each polymer electrolyte membrane and power generation characteristics of fuel cells manufactured using the polymer electrolyte membranes were evaluated. The testing methods of the proton conductivity and power generation characteristics were as follows.

Testing Method of Ionic Conductivity

Each polymer electrolyte membrane was cut in the form of a circle of 13 mmφ, inserted into a two-electrode platinum blocking electrode cell having a TEFLON (registered trade mark) housing, and the resultant cell was fixed in a thermostat. Then, the temperature of the thermostat was raised to 150° C. and the resultant was left sit for one day. Subsequently, the resistance of the cell was measured at a constant temperature of 150° C. using the SI1287 Electrochemical Interface and the SI1260 Impedance/gain phase Analyzer manufactured by Solartron, United Kingdom. The ionic conductivity of the polymer electrolyte membrane was calculated from the obtained bulk resistance and cell constant.

Testing Method of Power Generation Characteristics of Fuel Cell

The prepared polymer electrolyte membrane was cut to a size of 2.8 cm², and interposed between commercially available gas diffusion electrodes (catalyst-attached electrode manufactured by Electrochem, USA; electrode in which 1 mg/cm² of Pt as a catalyst was attached to carbon paper; EC-20-10-7) to prepare a simple membrane electrode assembly (MEA). Then, a TEFLON (registered trade mark) gasket and the MEA were interposed between carbon separators, each including a gas path therein. A current collector plate and an end plate were disposed over both electrodes. The resultant structure was rigidly tightened by bolts to prepare a test cell. The temperature of the test cell was raised to 150° C. while being purged with nitrogen, and then hydrogen and oxygen were directly (without using a humidifier) introduced into the test cell from a cylinder by using a mass flow controller to control the flow of fluid. Polarization characteristics in power generation and consecutive power generation characteristics were evaluated using an electrochemical measurement device HZ-3000 manufactured by Hokuto Electronics Industry Co., Ltd.

Synthesis of Polymer Electrolyte

Methods of synthesizing a polymer electrolyte according to aspects of the invention will now be described.

(A) Based on J. Kerres et al., Electrochem. Syst. 3 (2000) 129, polyetheretherketone is sulfonated to obtain a sulfonated polyetheretherketone represented by Formula 2 below (S-PEEK, equivalent weight (Ew)=570). In particular, 50g of polyetheretherketone (PEEK450P, manufactured by Mitsui Toatsu Chemicals Inc.) was dispersed in a 98% sulfuric acid, and the resultant dispersion was reacted at 35° C. for 24 hours. Then, the reaction solution was poured into cooling water little by little, and this process was repeated several times until the pH of the resultant solution was neutral. The Ew of the obtained sulfonated polyetheretherketone was determined to be 570 using combustion ion chromatography.

(B) Based on R. Guan et at., Euro Polym. J., 41 (2005) 1554, polyethersulfone was sulfonated to obtain a sulfonated polyethersulfone represented by Formula 3 below (S-PES, Ew=550). In particular, 20 g of polyethersulfone (poly 1,4-phenyleneethersulfone, manufactured by Aldrich) was dispersed in 100 ml of a 98% sulfuric acid, and the resultant dispersion was reacted at room temperature for two hours. Then, 80 ml of chlorosulfonic acid was slowly dropped into the dispersion, and the reaction solution was left sit for about one hour in order that the temperature thereof reached 10° C. As in the process (A) described above, the reaction solution was poured into cooling water little by little, and this process was repeated several times until the pH of the resultant solution was neutral. The Ew of the obtained sulfonated polyethersulfone was determined to be 550 using back titration. However, when the dropping amount of chlorosulfonic acid was 60 ml or 70 ml, unlike described in the paper described above, an expected degree of sulfonation could not be obtained according to the Ew of the obtained polymer. In this process, the EW of the polymer was 550, and the dropping amount of chlorosulfonic acid was 80 ml.

(C) Based on X. Glipa et al., Solid State Ionics 97 (1997) 323, polybenzimidazole was sulfonated to obtain a sulfonated polybenzimidazole represented by Formula 4 below (S=PBI, Ew=770). In particular, polybenzimidazole was previously synthesized as follows, and then ionized and sulfonated. 2.60 g of 3,4-diamino benzoate (manufactured by Tokyo Chemical Industry Co., Ltd), 1.83 g of 3,3′-diaminobenzidine (manufactured by Aldrich), and 1.42 g of isophthalic acid (manufactured by Tokyo Chemical Industry Co., Ltd) were added to 35 g of polyphosphoric acid (manufactured by Kishida Chemistry Co., Ltd.), and then the mixture was reacted at 200° C. for five hours. The reaction solution was poured in a large amount of cold water. Then, the resultant reaction solution was poured into cooling water little by little, and this process was repeated several times until the pH of the resultant solution was neutral. The resultant solution was dried in vacuum at 60° C. for 24 hours to obtain polybenzimidazole. Than, polybenzimidazole was dissolved in dimethylacetamide (manufactured by Kishida Chemistry Co., Ltd.), and lithiation reaction of the resultant was performed using lithium hydride (manufactured by Aldrich). In this regard, when the molar ratio of PBI:LiH disclosed in the paper described above is used, PBI:LiH reacts with moisture of impurities, thereby losing activity. Thus, the molar ratio of PBI:LiH used in the lithiation was 2:5.

Next, an excessive amount of the synthesized 4-bromomethylbenzenesulfonic acid was added to the resultant, and the mixture was stirred at 75° C. for 24 hours in a nitrogen atmosphere. Then, an excessive amount of tetrahydrofurane was added to the mixture to be reprecipitated.

Next, the resultant was dissolved once in dimethylacetamide, an insoluble portion of the resultant solution was filtered, and then the resultant was added to ultra-pure water. The precipitation was filtered, and then the resultant was dried in vacuum at 60° C. for 24 hours to obtain a sulfonated polybenzimidazole. Sulfur was quantitated by combustion ion chromatography used in the (A) process described above, and from this result, the Ew of the obtained sulfonated polybenzimidazole was determined to be 770.

Next, the prepared polymer solution was precipitated in water to obtain the polybenzimidazole-based polymer.

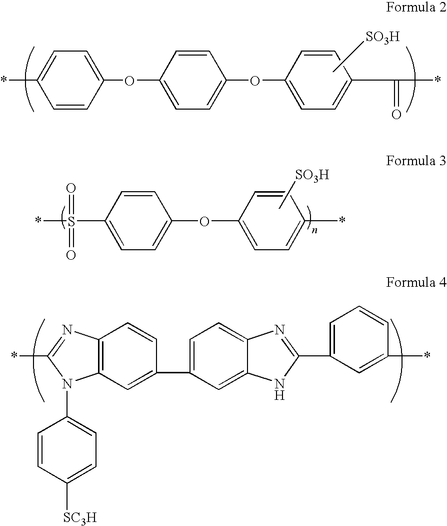

In addition, the solubility of unsulfonated polymer as a material of sulfonated polymer and sulfonated polymer with respect to the polar organic solvent and the compatibility of the unsulfonated polymer and the sulfonated polymer with respect to N-methylpyrrolidone (NMP) in which phosphoric acid was dissolved were evaluated. In this regard, NMP in which phosphoric acid was dissolved was obtained by dissolving 2.00 g of polyphosphoric acid (116 wt % phosphoric acid) in 12.00 g of NMP. The solubility of the unsulfonated polymer and the sulfonated polymer was determined according to whether a transparent solution could be prepared by adding 20 wt % of polymer to the polar organic solvent and stirring the mixture. The results are shown in Table 11 below.

TABLE 11

| | Dimethylacetamide | N-methylpyrrolidone | Phosphoric acid- |
|---|---|---|---|
| | (DMAc) | (NMP) | NMP |
| Polybenzimidazole | Soluble | Soluble | Precipitated |
| Polyetheretherketone | Insoluble | Insoluble | Insoluble |
| Polyethersulfone | Insoluble | Insoluble | Insoluble |
| Sulfonated | Soluble | Soluble | Soluble |
| polybenzimidazole | | | |
| Sulfonated | Soluble | Soluble | Soluble |
| polyetheretherketone | | | |
| Sulfonated | Soluble | Soluble | Soluble |
| polyethersulfone | | | |

As shown in Table 11, unsulfonated PEEK and unsulfonated PES are insoluble in both DMAc and NMP, and sulfonated PEEK and sulfonated PES are soluble in both DMAc and NMP. In addition, PBI is soluble in both DMAc and NMP, but is precipitated in NMP in which phosphoric acid is dissolved. However, sulfonated PBI is soluble in NMP in which phosphoric acid is dissolved. Thus, a polymer electrolyte membrane according to one or more embodiments was prepared as follows by using such sulfonated polymer.

### Example 1

2.50 g of the sulfonated polybenzimidazole (S-PBI) synthesized using the process described above was used. 2.50 g of polyphosphoric acid was added to 12.00 g of N-methylpyrrolidone (NMP) and the mixture was stirred at room temperature for one day.

Next, S-PBI and the NMP solution in which polyphosphoric acid was dissolved were added to a uniform phosphoric acid-NMP solution, and then the mixed solution was stirred at room temperature for three hours to obtain a uniformly mixed solution. The uniformly mixed solution was cast on a glass substrate by using a doctor blade to obtain a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 130 μm.

### Example 2

3.00 g of the sulfonated polyetheretherketone (S-PEEK) synthesized using the process described above was used. 2.00 g of polyphosphoric acid was added to 12.00 g of NMP and the mixture was stirred at room temperature for one day.

Next, S-PEEK and the NMP solution in which polyphosphoric acid was dissolved were added to a uniform phosphoric acid-NMP solution, and then the mixed solution was stirred at room temperature for three hours to obtain a uniformly mixed solution. The uniformly mixed solution was cast on a glass substrate by using a doctor blade to obtain a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 138 μm.

### Example 3

3.00 g of the sulfonated polyethersulfone (S-PES) synthesized using the process described above was used. 2.00 g of polyphosphoric acid was added to 12.00 g of NMP and the mixture was stirred at room temperature for one day.

Next, S-PES and the NMP solution in which polyphosphoric acid was dissolved were added to a uniform phosphoric acid-NMP solution. Then the mixed solution was stirred at room temperature for three hours to obtain a uniformly mixed solution. The uniformly mixed solution was cast on a glass substrate by using a doctor blade to obtain a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 135 μm.

### Example 4

3.00 g of the sulfonated polyetheretherketone (S-PEEK) synthesized using the process described above was used. 2.00 g of polyphosphoric acid and 1.00 g of benzimidazole were added to 12.00 g of NMP and the mixture was stirred at room temperature for one day.

Next, S-PEEK and the NMP solution in which polyphosphoric acid and benzimidazole were dissolved were added to a uniform phosphoric acid-NMP solution, and then the mixed solution was stirred at room temperature for three hours to obtain a uniformly mixed solution. The uniformly mixed solution was cast on a glass substrate by using a doctor blade to obtain a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 134 μm.

### Example 5

3.00 g of the sulfonated polyetheretherketone (S-PEEK) synthesized using the process described above was used. 2.00 g of polyphosphoric acid and 1.00 g of 1-methyl-3-butyltrifluorosulfoimide (EMITFSI) were added to 12.00 g of NMP and the mixture was stirred at room temperature for one day.

Next, S-PEEK and the NMP solution in which polyphosphoric acid and EMITFSI were dissolved were added to a uniform phosphoric acid-NMP solution, and then the mixed solution was stirred at room temperature for three hours to obtain a uniformly mixed solution. The uniformly mixed solution was cast on a glass substrate by using a doctor blade to obtain a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 125 μm.

### Example 6

3.00 g of the sulfonated polyetheretherketone (S-PEEK) synthesized using the process described above was used. 1.00 g of vinylphosphonic acid was added to 12.00 g of NMP and the mixture was stirred at room temperature for one day.

Next, S-PEEK and the NMP solution in which vinylphosphonic acid was dissolved were added to a uniform phosphoric acid-NMP solution, and then the mixed solution was stirred at room temperature for three hours to obtain a uniformly mixed solution. The uniformly mixed solution was cast on a glass substrate by using a doctor blade to obtain a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 125 μm.

### Example 7

3.00 g of the sulfonated polyetheretherketone (S-PEEK) synthesized using the process described above, 4.00 g of vinylphosphonic acid, 2.00 g of polyethyleneglycol dimethacrylate, and 0.3 g of azobisisobutyronitrile were dissolved in 10.00 g of dimethylacetamide, and the mixture was stirred at 25° C. for three hours to prepare a uniform solution. The uniform solution was cast on a glass substrate by using a doctor blade. Then, the resultant was dried at 80° C. for three hours to remove dimethylacetamide, and was heat-treated at 100° C. in vacuum for 19 hours at 150° C. for 0.5 hours to obtain a polymer electrolyte membrane. The polymer electrolyte membrane was detached from the glass substrate, thereby completing the preparation of the polymer electrolyte membrane. The thickness of the polymer electrolyte membrane was 175 μm. In addition, the polymer electrolyte membrane was immersed in hot water at 80° C. for 30 minutes, and an elution rate of acid and cross-linking agent components in the polymer electrolyte membrane before being immersed was calculated from the amounts of acid and cross-linking agent components that were eluted in hot water. The elution rate was 50%. In addition, the conductivity of the polymer electrolyte membrane at 150° C. was measured using an AC impedance method to be 0.61 mS/cm.

In addition, a method of measuring the elution rate described above will now be described in detail. That is, 0.07 g of the polymer electrolyte membrane was immersed in 2 g of pure water, and put into an oven at a temperature of 80° C. for 30 minutes. Thereafter, the polymer electrolyte membrane was taken out of the pure water, and 1 g of the pure water was put in a glass bottle and heated to a temperature of 150° C. for 30 minutes. The weight of the residues in the glass bottle was measured, and the elution rate was calculated using the following equation.

Elution rate (%)=[1−(weight of residues eluted from polymer electrolyte membrane)/(total weight of acid and cross-linking agent components in polymer electrolyte membrane)]×100.

### Example 8

A polymer electrolyte membrane was prepared in the same manner as in Example 7, except that 2.30 g of vinylphosphonic acid, 2.30 g of polyethyleneglycol dimethacrylate, and 0.2 g of azobisisobutyronitrile were used. The elution rate of acid and cross-linking agent components in the polymer electrolyte membrane was 5%, and the conductivity of the polymer electrolyte membrane at 150° C. was 0.02 mS/cm.

### Comparative Example 1

3.00 g of the sulfonated polyetheretherketone (S-PEEK) synthesized using the process described above was added to 12.00 g of NMP, and the mixture was stirred at room temperature for three hours to obtain a uniform solution. The uniform solution was cast on a glass substrate by using a doctor blade to prepare a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 80 μm.

### Comparative Example 2

3.00 g of the sulfonated polyetheretherketone (S-PEEK) synthesized using the process described above was added to 12.00 g of NMP in which 1.00 g of benzimidazole was dissolved, and the mixture was stirred at room temperature for three hours to obtain a uniform solution. The uniform solution was cast on a glass substrate by using a doctor blade to prepare a polymer electrolyte membrane. The polymer electrolyte membrane was pre-dried at 80° C. for three hours, and then dried at 120° C. for two hours to remove the solvent, NMP. Then, the resultant polymer electrolyte membrane was detached from the glass substrate, thereby completing the preparation of the polymer electrolyte membrane. The thickness of the polymer electrolyte membrane was 85 μm.

Evaluation Results of Ionic Conductivity

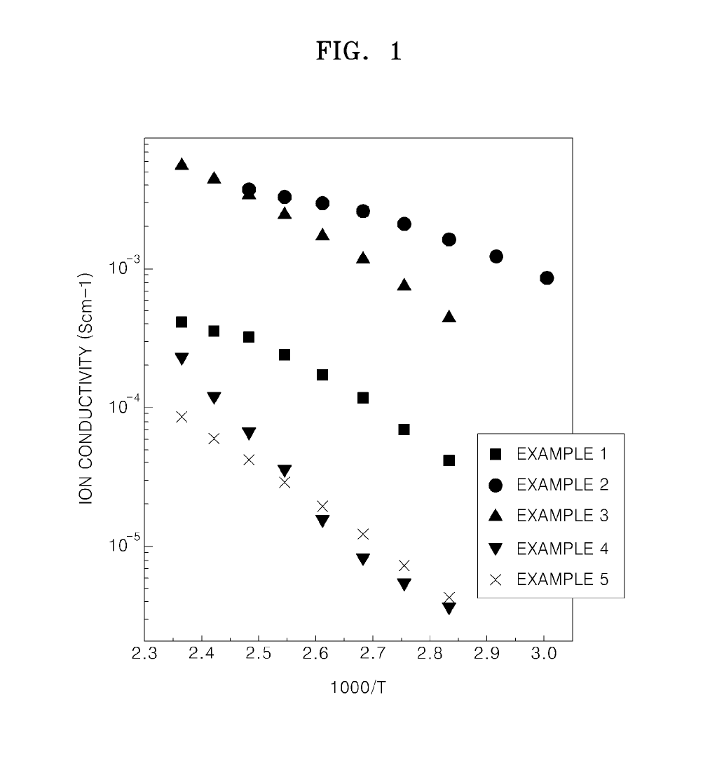

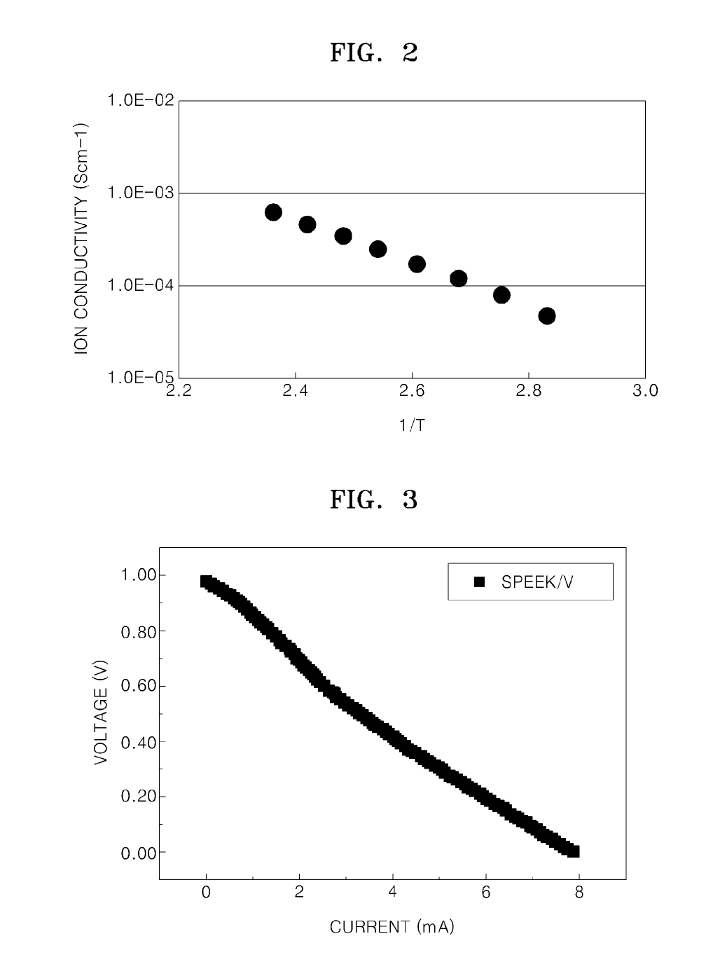

The measurement results of the proton conductivity of each of the polymer electrolyte membranes prepared in Examples 1 through 5 are shown in FIG. 1, and the measurement result of the proton conductivity of the polymer electrolyte membrane prepared in Example 8 is shown in FIG. 2. In particular, FIG. 1 illustrates Arrhenius plots representing the ionic conductivity of the polymer electrolyte membranes of Examples 1 through 5, wherein the y-axis denotes ionic conductivity [Scm⁻¹] and the x-axis denotes temperature (1000/T)[K⁻¹]. In addition, FIG. 2 is an Arrhenius plot representing the ionic conductivity of the polymer electrolyte membrane of Example 8, wherein the y-axis denotes ionic conductivity [Scm⁻¹] and the x-axis denotes temperature (1/T)[K⁻¹].

As illustrated in FIGS. 1 and 2, it can be seen that the polymer electrolyte membranes of Examples 1 through 5 and 8 have sufficient proton conductivity capable of generating power even at a high temperature (i.e., about 150° C.) in non-humidified conditions.

Evaluation Results of Power Generation Characteristics

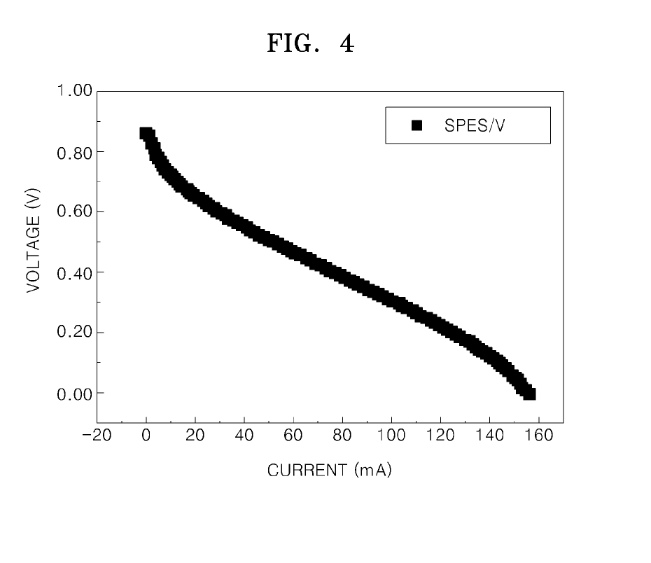

Test fuel cells were manufactured using the method described above by using the polymer electrolyte membranes prepared in Examples 2 and 3, and the evaluation results of power generation characteristics (polarization characteristics) of the polymer electrolyte membranes of Examples 2 and 3 are respectively illustrated in FIGS. 3 and 4. FIG. 3 is a graph representing a polarization curve of the test fuel cell manufactured using the polymer electrolyte membrane of Example 2, wherein the y-axis denotes voltage [V] and the x-axis denotes current [mA]. In addition, FIG. 4 is a graph representing a polarization curve of the test fuel cell manufactured using the polymer electrolyte membrane of Example 3, wherein the y-axis denotes voltage [V] and the x-axis denotes current [mA].

As illustrated in FIGS. 3 and 4, it can be seen that the test fuel cells manufactured using the polymer electrolyte membranes of Examples 2 and 3 have excellent polarization characteristics even at a high temperature (i.e., about 150° C.) in non-humidified conditions. In addition, referring to FIGS. 3 and 4, the open circuit voltage (OCV) of the test fuel cell of Example 2 is 0.987[V], and the OCV of the test fuel cell of Example 3 is 0.872[V]. That is, both test fuel cells had very high OCV.

As described above, according to the one or more of the above embodiments, there are provided a polymer electrolyte membrane in which a polymer electrolyte having an acidic functional group and a free acid such as phosphoric acid are dissolved together in a polar organic solvent and the mixed solution is subjected to wet membrane formation to prepare an acid-doped polymer electrolyte membrane, and thus the polymer electrolyte membrane is stabilized even at high temperatures in non-humidified conditions, thereby having high proton conductivity, a method of preparing a polymer electrolyte membrane, which is used to prepare the polymer electrolyte membrane described above and has high productivity, and a fuel cell with high power generation characteristics by using the polymer electrolyte membrane.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of preparing a polymer electrolyte membrane, comprising
preparing a mixed solution by dissolving a polymer electrolyte in a polar organic solvent, the polymer electrolyte having an acidic functional group and one free acid source selected from the group consisting of a free acid, mixtures of a free acid and Lewis acid, and mixtures of a free acid and an organic salt; and
subjecting the mixed solution to wet membrane formation in order to prepare a polymer electrolyte membrane in which the polymer electrolyte is doped with the free acid.

2. The method of claim 1, wherein the dissolved polymer electrolyte comprises, as a main backbone, an aromatic engineering plastic.

3. The method of claim 2, wherein the aromatic engineering plastic comprises polyethersulfone or polybenzimidazole.

4. The method of claim 1, wherein the free acid comprises an acidic inorganic phosphorus compound or an acidic organic phosphorus compound.

5. The method of claim 4, wherein the acidic inorganic phosphorus compound comprises phosphoric acid, polyphosphoric acid, or phosphonic acid.

6. The method of claim 4, wherein the acidic organic phosphorus compound comprises vinylphosphonic acid or ethylphosphonic acid.

7. The method of claim 1, wherein the organic salt comprises a quaternary ammonium cation.

8. The method of claim 1, wherein the polar organic solvent comprises an amide-based organic solvent.

9. The method of claim 8, wherein the amide-based organic solvent comprises dimethylacetamide, N-methyl-2-pyrrolidone, or dimethylformamide.

10. The method of claim 1, wherein a molar number (nA) of the acidic functional group in the polymer electrolyte, a molar number (nB) of the free acid, and a molar number (nC) of the Lewis base satisfy an inequality of nA+nB>nC.

11. The method of claim 1, wherein the amount of the free acid dissolved in the polar organic solvent is in the range of about 20 to about 80 parts by weight based on 100 parts by weight of the polymer electrolyte.

12. The method of claim 1, wherein the free acid comprises vinylphosphonic acid, and after the wet membrane formation, and the method further comprises doping the vinylphosphonic acid in the polymer electrolyte and polymerizing the doped polymer electrolyte.

13. The method of claim 12, wherein the preparing the mixed solution further comprises further dissolving a multi-functional polymerizable compound in the polar organic solvent, and after the wet membrane formation, the polymerization comprises co-polymerizing the multi-functional polymerizable compound and the vinylphosphonic acid.

14. The method of claim 13, wherein the multi-functional polymerizable compound comprises a multi-functional vinyl compound, diacrylate, or dimethacrylate.

15. A polymer electrolyte membrane that comprises, as a main backbone, an aromatic engineering plastic having an acidic functional group, and is doped with a free acid comprising an acidic inorganic phosphorus compound or an acidic organic phosphorus compound.

16. The polymer electrolyte membrane of claim 15, wherein the aromatic engineering plastic comprises polyethersulfone or polybenzimidazole.

17. The polymer electrolyte membrane of claim 15, wherein the acidic inorganic phosphorus compound comprises phosphoric acid, polyphosphoric acid or phosphonic acid.

18. The polymer electrolyte membrane of claim 15, wherein the acidic organic phosphorus compound comprises vinylphosphonic acid or ethylphosphonic acid.

19. A fuel cell comprising a membrane electrode assembly using the polymer electrolyte membrane, wherein the polymer electrolyte membrane that comprises, as a free backbone, an aromatic engineering plastic having an acidic functional group, and is doped with a free acid comprising an acidic inorganic phosphorus compound or an acidic organic phosphorous compound.

20. The fuel cell comprising a membrane electrode assembly of claim 19, wherein the aromatic engineering plastic comprises polyethersulfone or polybenzimidazole.

21. The fuel cell comprising a membrane electrode assembly of claim 19, wherein the acidic inorganic phosphorus compound comprises phosphoric acid, polyphosphoric acid or phosphonic acid.

22. The fuel cell comprising a membrane electrode assembly of claim 19, wherein the acidic organic phosphorus compound comprises vinylphosphonic acid or ethylphosphonic acid.
